(19) United States
(12) Patent Application Publication
(10) Pub. No.: US 2019/0152196 A1
(43) Pub. Date: May 23, 2019

(54) CONDUCTIVE MULTILAYER SHEET FOR THERMAL FORMING AND INJECTION MOLDING APPLICATIONS

(71) Applicant: SABIC Global Technologies B.V., Bergen op Zoom (NL)

(72) Inventors: Yuzhen Xu, Shanghai (CN); Wei Feng, Shanghai (CN); Zhe Chen, Shanghai (CN); Yonglei Xu, Shanghai (CN); Tsan-Ming Chen, Taipei (TW)

(21) Appl. No.: 15/759,566

(22) PCT Filed: Sep. 13, 2016
(86) PCT No.: PCT/IB2016/055457

§ 371 Date: Mar. 13, 2018

Related U.S. Application Data
(60) Provisional application No. 62/218,219, filed on Sep. 14, 2015.

(51) Int. Cl. B32B 27/08; B32B 27/36; B29C 45/14; B29B 11/06

(52) U.S. Cl. CPC B32B 27/08; B32B 27/365; B29C 45/1418; B29B 11/06; B29C 45/14336; B32B 2255/10; B32B 2457/12; B32B 2255/26; B32B 2255/28; B32B 2264/105; B32B 2307/202; B32B 2307/412; B32B 2457/208; B32B 2255/205

(57) ABSTRACT

A method of forming an article of manufacture, comprising: forming a mold insert, comprising applying a conductive layer on a donor substrate second surface, wherein the conductive layer includes nanometer sized metal particles arranged in a network; applying an ultraviolet curable coating layer to a recipient substrate first surface; pressing the recipient substrate, the ultraviolet curable coating layer, and the donor substrate together to form a stack; heating the stack and activating the ultraviolet cured coating layer with an ultraviolet radiation source; removing the donor substrate from the stack, wherein the ultraviolet curable coating layer adheres to the recipient substrate first surface and the conductive layer; thermoforming the mold insert; and injection molding a polymeric resin layer around a portion of the recipient substrate second surface.

### BACKGROUND

Conductive layers can be useful in a variety of electronic devices. These layers can provide a number of functions such as electromagnetic interference shielding and electrostatic dissipation. These layers can be used in many applications including, but not limited to, touch screen displays, wireless electronic boards, photovoltaic devices, conductive textiles and fibers, organic light emitting diodes, electroluminescent devices, and electrophoretic displays, such as e-paper.

Conductive layers can include a network-like pattern of conductive traces formed of metal. The conductive layer can be applied to a substrate as a wet coating which can be sintered to form these networks. However, some substrate materials can be damaged by a sintering process. Additionally, it can be difficult to thermoform articles from the substrates with the conductive layers and conductivity can suffer from substrates which are thermoformed.

Thus, there is a need in the art for a coating layer which can provide strong adhesion between a conductive layer and a substrate, as well as allowing the substrate to be thermoformed and injection mold decorated without a loss in mechanical properties.

### BRIEF DESCRIPTION

Disclosed herein are articles of manufacture and methods of making articles of manufacture.

An article of manufacture, comprising: a mold insert comprising a substrate including a substrate first surface and a substrate second surface; an ultraviolet curable coating layer including a coating first surface and a coating second surface, wherein the ultraviolet curable coating layer comprises a multifunctional acrylate oligomer; and an acrylate monomer; wherein the ultraviolet curable coating layer includes a total weight, wherein 30% to 80% of the total weight comprises the multifunctional acrylate oligomer, and wherein 15% to 65% of the total weight comprises the acrylate monomer, wherein the coating first surface of the ultraviolet curable coating layer is adjacent to the substrate first surface; and a conductive layer adjacent to the coating second surface, wherein the conductive layer includes nanometer sized metal particles arranged in a network; and a polymeric resin layer coupled to a portion of the substrate second surface.

A method of forming an article of manufacture, comprising: forming a mold insert, comprising applying a conductive layer on a donor substrate second surface, wherein the conductive layer includes nanometer sized metal particles arranged in a network; applying an ultraviolet curable coating layer to a recipient substrate first surface; pressing the recipient substrate, the ultraviolet curable coating layer, and the donor substrate together to form a stack; heating the stack and activating the ultraviolet cured coating layer with an ultraviolet radiation source; removing the donor substrate from the stack, wherein the ultraviolet curable coating layer adheres to the recipient substrate first surface and the conductive layer; thermoforming the mold insert; and injection molding a polymeric resin layer around a portion of the recipient substrate second surface.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustration of a cross-sectional view of a conductive sheet or film including a conductive layer transferred thereto.

FIG. 2 is an illustration of a cross-sectional view of a portion of a conductive sheet or film including a conductive layer transferred thereto and a coated substrate.

FIG. 3 is an illustration of various testing locations on a thermoformed part including a conductive layer and an ultraviolet curable coating layer.

FIG. 4 is a microscopic picture of a mold insert having a SR value of “∞.”

### DETAILED DESCRIPTION

It can be difficult to thermoform multilayer sheets that include a conductive layer since the conductive layer can be brittle and therefore, can break easily. Disclosed herein is an article of manufacture including a mold insert and a polymeric resin coupled to the mold insert, wherein the mold insert includes a conductive layer including nanometer sized metal particles arranged in a network. Further disclosed herein is a method of thermoforming the mold insert and injection molding a polymeric resin layer to the mold insert to form an article.

The mold insert can include a substrate, an ultraviolet curable coating layer, and a conductive layer. The conductive layer can be disposed between the substrate and the ultraviolet curable coating layer. The ultraviolet light curable coating layer can be disposed between the substrate and the conductive layer. The substrate can include a substrate first surface and a substrate second surface, where the substrate second surface can be an outermost surface of the mold insert.

The ultraviolet light curable coating layer can include a coating first surface and a coating second surface, where the coating first surface can be disposed on the substrate first surface. The ultraviolet light curable coating layer can be disposed on a conductive layer first surface. The conductive layer can be adjacent to the coating second surface.

The conductive layer can be directly coated on the substrate. The substrate can be the substrate on which the conductive layer is originally formed or can be a substrate to which the conductive layer is transferred after formation. The conductive layer can be directly coated on the ultraviolet light curable coating layer, for example, on the coating second surface.

The ultraviolet curable coating layer can include a multifunctional acrylate oligomer and an acrylate monomer. The ultraviolet curable coating layer can include a photoinitiator. The multifunctional acrylate oligomer can include an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing. In an embodiment, the multifunctional acrylate can include DOUBLEMER™ 5272 (DM5272) (commercially available from Double Bond Chemical Ind., Co., LTD., of Taipei, Taiwan, R.O.C.) which includes an aliphatic urethane acrylate oligomer in an amount from 30 weight percent (wt. %) to 50 wt. % of the multifunctional acrylate and a pentaerythritol tetraacrylate in an amount from 50 wt. % to 70 wt. % of the multifunctional acrylate.

The ultraviolet curable coating layer can optionally include a polymerization initiator to promote polymerization of the acrylate components. The optional polymerization initiators can include photoinitiators that promote polymerization of the components upon exposure to ultraviolet radiation.

The ultraviolet curable coating layer can include the multifunctional acrylate oligomer in an amount of 30 wt. % to 90 wt. % for example, 30 wt. % to 85 wt. %, or, 30 wt. % to 80 wt. %; the acrylate monomers in an amount of 5 wt. % to 65 wt. %, for example, 8 wt. % to 65 wt. %, or, 15 wt. % to 65 wt. %; and the optional photoinitiator present in an amount of 0 wt. % to 10 wt. %, for example, 2 wt. % to 8 wt. %, or, 3 wt. % to 7 wt. %, wherein weight is based on the total weight of the ultraviolet curable coating layer.

An aliphatic urethane acrylate oligomer can include 2 to 15 acrylate functional groups, for example, 2 to 10 acrylate functional groups.

The acrylate monomer (e.g., 1,6-hexanediol diacrylate, meth(acrylate) monomer) can include 1 to 5 acrylate functional groups, for example, 1 to 3 acrylate functional group(s). In an embodiment, the acrylate monomer can be 1,6-hexanediol diacrylate (HDDA), for example, 1,6-hexanediol diacrylate commercially available from SIGMA-ALDRICH.

The multifunctional acrylate oligomer can include a compound produced by reacting an aliphatic isocyanate with an oligomeric diol such as a polyester diol or polyether diol to produce an isocyanate capped oligomer. This oligomer can then be reacted with hydroxy ethyl acrylate to produce the urethane acrylate.

The multifunctional acrylate oligomer can be an aliphatic urethane acrylate oligomer, for example, a wholly aliphatic urethane (meth)acrylate oligomer based on an aliphatic polyol, which is reacted with an aliphatic polyisocyanate and acrylated. In one embodiment, the multifunctional acrylate oligomer can be based on a polyol ether backbone. For example, an aliphatic urethane acrylate oligomer can be the reaction product of (i) an aliphatic polyol; (ii) an aliphatic polyisocyanate; and (iii) an end capping monomer capable of supplying reactive terminus. The polyol (i) can be an aliphatic polyol, which does not adversely affect the properties of the composition when cured. Examples include polyether polyols; hydrocarbon polyols; polycarbonate polyols; polyisocyanate polyols, and mixtures thereof.

The multifunctional acrylate oligomer can include an aliphatic urethane tetraacrylate (i.e., a maximum functionality of 4) that can be diluted 20% by weight with a acrylate monomer, e.g., 1,6-hexanediol diacrylate (HDDA), tripropyleneglycol diacrylate (TPGDA), and trimethylolpropane triacrylate (TMPTA). A commercially available urethane acrylate that can be used in forming the ultraviolet curable coating layer can be EBECRYL™ 8405, EBECRYL™8311, EBECRYL™ 8807, EBECRYL™ 303, or EBECRYL™ 8402, each of which is commercially available from Allnex.

Some commercially available oligomers which can be used in the ultraviolet curable coating layer can include, but are not limited to, multifunctional acrylates that are part of the following families: the PHOTOMER™ Series of aliphatic urethane acrylate oligomers from IGM Resins, Inc., St. Charles, Ill.; the Sartomer SR Series of aliphatic urethane acrylate oligomer from Sartomer Company, Exton, Pa.; the Echo Resins Series of aliphatic urethane acrylate oligomers from Echo Resins and Laboratory, Versailles, Mo.; the BR Series of aliphatic urethane acrylates from Bomar Specialties, Winsted, Conn.; the DOUBLEMER™ Series of aliphatic oligomers from Double Bond Chemical Ind., Co., LTD., of Taipei, Taiwan, R.O.C.; and the EBECRYL™ Series of aliphatic urethane acrylate oligomers from Allnex. For example, the aliphatic urethane acrylates can be KRM8452 (10 functionality, Allnex), EBECRYL™ 1290 (6 functionality, Allnex), EBECRYL™ 1290 N (6 functionality, Allnex), EBECRYL™ 512 (6 functionality, Allnex), EBECRYL™ 8702 (6 functionality, Allnex), EBECRYL™ 8405 (3 functionality, Allnex), EBECRYL™ 8402 (2 functionality, Allnex), EBECRYL™ 284 (3 functionality, Allnex), CN9010™ (Sartomer), CN9013™ (Sartomer), SR351 (Sartomer) or Laromer TMPTA (BASF), SR399 (Sartomer) dipentaerythritol pentaacrylate esters and dipentaerythritol hexaacrylate DPHA (Allnex), CN9010 (Sartomer), SR306 (tripropylene glycol diacrylate, Sartomer), CN8010 (Sartomer), CN981 (Sartomer), PM6892 (IGM), DOUBLEMER™ DM5272 (Double Bond), DOUBLEMER™ DM321HT (Double Bond), DOUBLEMER™ DM353L (Double Bond), DOUBLEMER™ DM554 (Double Bond), DOUBLEMER™ DM5222 (Double Bond), and DOUBLEMER™ DM583-1 (Double Bond).

Another component of the ultraviolet curable coating layer can be an acrylate monomer having one or more acrylate or methacrylate moieties per monomer molecule. The acrylate monomer can be mono-, di-, tri-, tetra- or penta functional. In one embodiment, di-functional monomers are employed for the desired flexibility and adhesion of the coating. The monomer can be straight- or branched-chain alkyl, cyclic, or partially aromatic. The reactive monomer diluent can also comprise a combination of monomers that, on balance, result in a desired adhesion for a coating composition on the substrate, where the coating composition can cure to form a hard, flexible material having the desired properties.

The acrylate monomer can include monomers having a plurality of acrylate or methacrylate moieties. These can be di-, tri-, tetra- or penta-functional, specifically di-functional, in order to increase the crosslink density of the cured coating and therefore can also increase modulus without causing brittleness. Examples of polyfunctional monomers include, but are not limited, to C₆-C₁₂ hydrocarbon diol diacrylates or dimethacrylates such as 1,6-hexanediol diacrylate (HDDA) and 1,6-hexanediol dimethacrylate; tripropylene glycol diacrylate or dimethacrylate; neopentyl glycol diacrylate or dimethacrylate; neopentyl glycol propoxylate diacrylate or dimethacrylate; neopentyl glycol ethoxylate diacrylate or dimethacrylate; 2-phenoxylethyl (meth)acrylate; alkoxylated aliphatic (meth)acrylate; polyethylene glycol (meth)acrylate; lauryl (meth)acrylate, isodecyl (meth)acrylate, isobornyl (meth)acrylate, tridecyl (meth)acrylate; and mixtures comprising at least one of the foregoing monomers. For example, the acrylate monomer can be 1,6-hexanediol diacrylate (HDDA), alone or in combination with another monomer, such as tripropyleneglycol diacrylate (TPGDA), trimethylolpropane triacrylate (TMPTA), oligotriacrylate (OTA 480), or octyl/decyl acrylate (ODA).

Another component of the ultraviolet curable coating layer can be an optional polymerization initiator such as a photoinitiator. Generally, a photoinitiator can be used if the coating composition is to be ultraviolet cured; if it is to be cured by an electron beam, the coating composition can comprise substantially no photoinitiator.

When the ultraviolet curable coating layer is cured by ultraviolet light, the photoinitiator, when used in a small but effective amount to promote radiation cure, can provide reasonable cure speed without causing premature gelation of the coating composition. Further, it can be used without interfering with the optical clarity of the cured coating material. Still further, the photoinitiator can be thermally stable, non-yellowing, and efficient.

Photoinitiators can include, but are not limited to, the following: α-hydroxyketone; hydroxycyclohexylphenyl ketone; hydroxymethylphenylpropanone; dimethoxyphenylacetophenone; 2-methyl-1-[4-(methylthio)phenyl]-2-morpholinopropanone-1; 1-(4-isopropylphenyl)-2-hydroxy-2-methylpropan-1-one; 1-(4-dodecylphenyl)-2-hydroxy-2-methylpropan-1-one; 4-(2-hydroxyethoxy) phenyl-(2-hydroxy-2-propyl) ketone; diethoxyacetophenone; 2,2-di-sec-butoxyacetophenone; diethoxy-phenyl acetophenone; bis (2,6-dimethoxybenzoyl)-2,4-, 4-trimethylpentylphosphine oxide; 2,4,6-trimethylbenzoyldiphenylphosphine oxide; 2,4,6-trimethylbenzoylethoxyphenylphosphine oxide; and combinations comprising at least of the foregoing.

Exemplary photoinitiators can include phosphine oxide photoinitiators. Examples of such photoinitiators include the IRGACURE™, LUCIRIN™ and DAROCURE™ series of phosphine oxide photoinitiators available from BASF Corp.; the ADDITOL™ series from Allnex; and the ESACURE™ series of photoinitiators from Lamberti, s.p.a. Other useful photoinitiators include ketone-based photoinitiators, such as hydroxy- and alkoxyalkyl phenyl ketones, and thioalkylphenyl morpholinoalkyl ketones. Also desirable can be benzoin ether photoinitiators. Specific exemplary photoinitiators include bis(2,4,6-trimethylbenzoyl)-phenylphosphine oxide supplied as IRGACURE™ 819 by BASF or 2-hydroxy-2-methyl-1-phenyl-1-propanone supplied as ADDITOL HDMAP™ by Allnex or 1-hydroxy-cyclohexyl-phenyl-ketone supplied as IRGACURE™ 184 by BASF or RUNTECURE™ 1104 by Changzhou Runtecure chemical Co. Ltd, or 2-hydroxy-2-methyl-1-phenyl-1-propanone supplied as DAROCURE™ 1173 by BASF.

The photoinitiator can be chosen such that the curing energy is less than 2.0 Joules per square centimeter (J/cm²), and specifically less than 1.0 J/cm², when the photoinitiator is used in the designated amount.

The polymerization initiator can include peroxy-based initiators that can promote polymerization under thermal activation. Examples of useful peroxy initiators include benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di (trimethylsilyl)peroxide, trimethylsilylphenyltriphenylsilyl peroxide, and the like, and combinations comprising at least one of the foregoing polymerization initiators.

A conductive layer can contain an electromagnetic shielding material. The conductive layer can include a conductive material. Conductive materials can include pure metals such as silver (Ag), nickel (Ni), copper (Cu), metal oxides thereof, combinations comprising at least one of the foregoing, or metal alloys comprising at least one of the foregoing, or metals or metal alloys produced by the Metallurgic Chemical Process (MCP) described in U.S. Pat. No. 5,476,535. Metals of the conductive layer can be nanometer sized, e.g., such as where 90% of the particles can have an equivalent spherical diameter of less than 100 nanometers (nm). The metal particles can be sintered to form a network of interconnected metal traces defining randomly shaped openings on the substrate surface to which it is applied. The sintering temperature of the conductive layer can be 300° C. which can exceed the heat deflection temperature of some substrate materials. After sintering, the surface resistance of the conductive layer can be less than or equal to 0.1 ohm per square (ohm/sq). The conductive layer can have a surface resistance of less than 1/10th of the surface resistance of an indium tin oxide coating. The conductive layer can be transparent.

Unlike networks formed of nanometer sized metal wires, the conductive network formed of nanometer sized metal particles can be bent without reducing the conductivity and/or increasing the electrical resistance of the conductive network. For example, networks of metal wires can separate at junctions when bent, which can reduce the conductivity of the wire network, whereas the metal network of nanometer sized particles can deform elastically without separating traces of the network, thereby maintaining the conductivity of the network.

The conductive layer can be disposed adjacent to a surface of a substrate, e.g., a donor substrate. The conductive layer can be formed on a substrate, e.g., donor substrate, and after formation, the conductive layer can be transferred to another substrate, e.g., recipient substrate. The conductive layer can be applied to a substrate using any wet coating technique, e.g., screen printing, spreading, spray coating, spin coating, dipping, and the like. The conductive layer can be applied to the UV curable coating layer disposed on the substrate first surface, wherein after curing, the conductive layer is adhered to the substrate.

The substrate can be any shape. The substrate can have a first surface and a second surface (e.g., a substrate first surface and a substrate second surface). The substrate can include a polymer, a glass, or a combination of polymer and glass. The substrate first can comprise a first polymer. The substrate second surface can comprise a second polymer. The substrate first surface can be disposed opposite the substrate second surface. The substrate first surface can consist of the first polymer. The substrate second surface can consist of the second polymer. The substrate first surface can consist of the first polymer and the substrate second surface can consist of the second polymer. The first polymer and the second polymer can be co-extruded to form the substrate. The first polymer and the second polymer can be different polymers, e.g. can comprise different chemical compositions. The substrate can be flat and can include the first surface and the second surface where the second surface can be disposed opposite the first surface, such as co-extruded forming opposing sides of the substrate. The substrate can be flexible.

The ultraviolet curable coating layer can be disposed adjacent to a surface of the substrate (e.g., dispersed across the surface of the substrate). The ultraviolet curable coating layer can abut a surface of the substrate. The ultraviolet curable coating layer can be used to transfer the conductive layer from a donor substrate to a recipient substrate. The ultraviolet curable coating layer can have a greater adhesion to the recipient substrate than to the donor substrate, such that when the ultraviolet curable coating layer is sandwiched between the recipient substrate and the donor substrate and the donor substrate is removed, the ultraviolet curable coating layer can preferentially adhere to the recipient substrate rather than to the donor substrate. The ultraviolet curable coating layer can be in mechanical communication with both the nano-metal network of the conductive layer and a surface of a substrate.

The ultraviolet curable coating layer can be disposed on a surface of the conductive layer. The substrate can be a donor substrate to which a conductive layer is adhered, or can be a recipient substrate that can receive the conductive layer from the donor substrate. The ultraviolet curable coating layer can be applied to the conductive layer, which can be applied to a donor substrate, such that the conductive layer can be disposed between the ultraviolet curable coating layer and the donor substrate. The donor substrate including a conductive layer and an ultraviolet curable coating layer can be coupled to a recipient substrate such that the conductive layer can abut a surface of the recipient substrate and can be sandwiched between the conductive layer and a surface of the recipient substrate. The donor substrate can then be removed and the ultraviolet curable coating layer and the conductive layer can be left adhered to the recipient substrate. The ultraviolet curable coating layer can at least partially surround the conductive layer. The conductive layer can be at least partially embedded in the ultraviolet curable coating layer, such that a portion of the ultraviolet curable coating layer can extend into an opening in the nano-metal network of the conductive layer.

The donor substrate, including the conductive layer, can be coupled to the ultraviolet curable coating layer where the conductive layer can be disposed on the surface of the recipient substrate, and the donor substrate can be removed such that the conductive layer can remain coupled to the ultraviolet curable coating layer and adjacent to the recipient substrate. The donor substrate can include a polymer that is capable of withstanding the conductive layer sintering temperature without damage.

A substrate can optionally include a substrate coating disposed on a surface of the substrate. For example, the substrate coating can be disposed on an outermost surface of the substrate, e.g., the first surface. The substrate coating can be disposed on two opposing surfaces of the substrate. The substrate coating can provide a protective portion to the substrate. The protective portion, such as an acrylic hard coat, can provide abrasion resistance to the underlying substrate. The protective portion can be disposed adjacent to a surface of the substrate. The protective portion can abut a surface of the substrate. The protective portion can be disposed opposite the conductive layer. The protective portion can include a polymer. In an embodiment, a substrate coating can include a polymeric coating offering good pencil hardness (e.g., 4-5H measured according to ASTM D3363 on polymethyl methacrylate or HB-F measured according to ASTM D3363 on polycarbonate) and chemical/abrasion resistance, together with desirable processing characteristics. For example, the substrate coating can include a coating such as a LEXAN™ OQ6DA film, commercially available from SABIC's Innovative Plastics Business or a similar acrylic based or silicon based coating, film, or coated film, which can provide enhanced pencil hardness, enhanced chemical resistance, variable gloss and printability, enhanced flexibility, and/or enhanced abrasion resistance. The coating can be 0.1 millimeter (mm) to 2 mm thick, for example, 0.25 mm to 1.5 mm, or, 0.5 mm to 1.2 mm thick. The coating can be applied on one or more sides of the substrate. For example, the substrate coating can include an acrylic hard coat.

The mold insert can be injection mold decorated with a polymeric resin layer, such that the polymeric resin layer is deposited onto the substrate second surface. The polymeric resin layer may include polycarbonate, poly(methylmethacrylate) (PMMA),), polyethylene terephthalate (PET), polyethylene naphthalate (PEN), a cyclic olefin copolymer (COC), polyetherimide (PEI), polypropylene (PP), polyethylene (PE), poly(p-phenylene oxide) (PPO), polyether ether ketone (PEEK), or a combination thereof. The polymeric resin layer may include particles, fibers, wires, or a combination comprising at least one of the foregoing.

A decorative image can be applied to the polymer resin layer after injection molding. The decorative image can be formed from a thermochromic polymeric material.

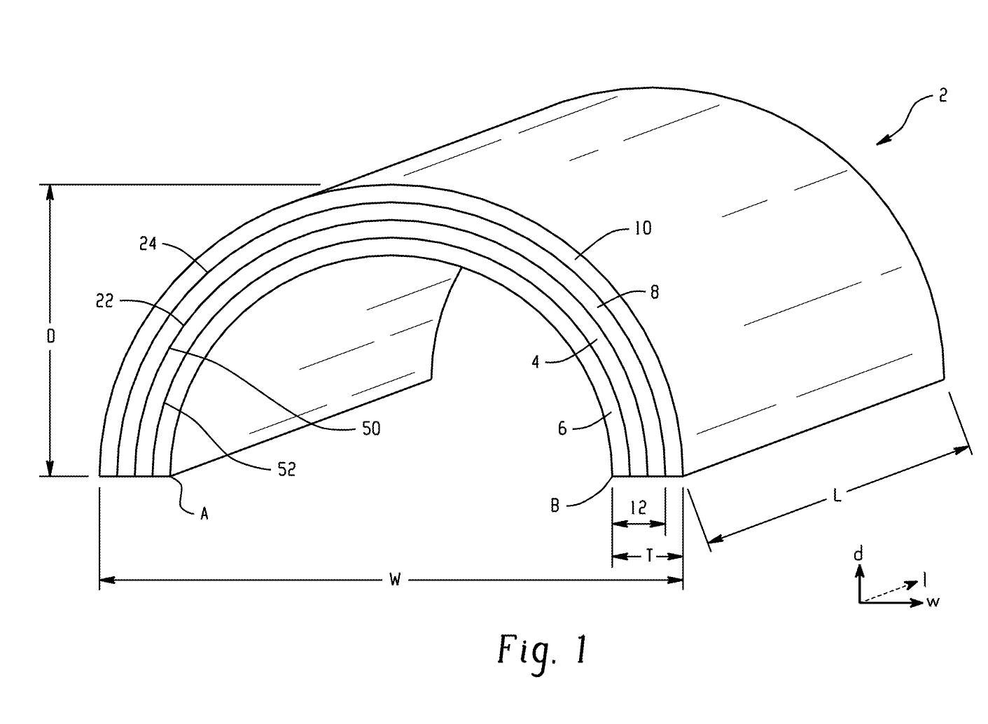

FIG. 1 is an illustration of an article 2 including a molded insert 12 and a polymer resin layer 10. The article 2 can include a conductive layer 6, an ultraviolet curable coating layer 4, a substrate 8, and polymer resin layer 10. The electrical conductivity of the article 2 can be measured from point A to point B. The substrate can include a substrate first surface 22 and a substrate second surface 24. The conductive layer 6 can be disposed adjacent to the first surface 22 of the substrate 8. The conductive layer 6 can be applied directly to the substrate first surface 22 or the conductive layer 6 can be applied to the substrate first surface 22 via the UV curable coating layer 6.

The conductive layer 6 can have a conductive layer first surface 50 and a conductive layer second surface 52. A donor substrate can be coupled to a conductive layer second surface 52, such that the conductive layer 6 can be sandwiched between the ultraviolet curable coating layer 4 adjacent to the substrate first surface 22 and the donor substrate. The ultraviolet curable coating layer 4 can be adjacent to the conductive layer first surface 50. The donor substrate can be removed from the conductive layer second surface 52, leaving the conductive layer 6 and the ultraviolet curable coating layer 4 adjacent to the substrate first surface 22.

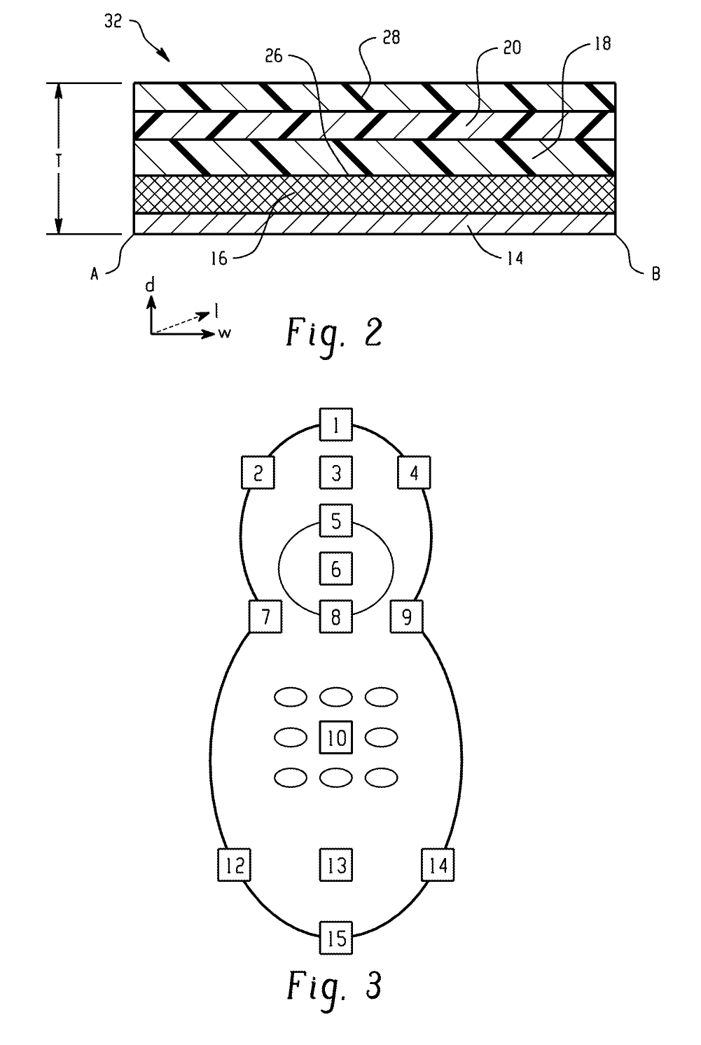

FIG. 2 is an illustration of a portion of a cross-section of an article 32. The article 32 can include a conductive layer 14, an ultraviolet curable coating layer 16, an optional first substrate coating 18, a substrate 20, and a polymeric resin layer 28. The electrical conductivity of the article 32 can be measured from point A to point B. An optional first substrate coating 18 can be disposed adjacent to the substrate 20 such that the ultraviolet curable coating layer 16 can be adhered to a surface 26 of the optional first substrate coating 18, and adjacent to the substrate 20. The conductive layer 14 can be at least partially surrounded by portions of the ultraviolet curable coating layer 16, such that portions of the ultraviolet curable coating layer 16 can extend into openings in the nano-metal network of the conductive layer 14.

The article can transmit greater than or equal to 50% (e.g. 50 percent transmittance) of incident visible light (e.g., electromagnetic radiation having a frequency of 430 THz to 790 THz), for example, 60% to 100%, or, 70% to 100%. A transparent polymer, substrate, coating, film, and/or material of the sheet or film can transmit greater than or equal to 50% of incident EMR having a frequency of 430 THz to 790 THz, for example, 75% to 100%, or, 90% to 100%. Transparency is described by two parameters, percent transmission and percent haze. Percent transmittance and percent haze for laboratory scale samples can be determined using ASTM D1003, Procedure A using CIE standard illuminant C using a Haze-Gard test device. ASTM D1003 (Procedure B, Spectrophotometer, using illuminant C with diffuse illumination with unidirectional viewing) defines percent transmittance as:

$$\% T = ( \frac{I}{{I}_{o}} ) \times 100 \% \qquad [ 1 ]$$

wherein: I is the intensity of the light passing through the test sample and Iₒ is the Intensity of incident light.

The mold insert can be prepared by applying a conductive layer on a donor substrate second surface, applying an ultraviolet curable coating layer to a recipient substrate first surface, pressing the recipient substrate, the ultraviolet curable coating layer, and the donor substrate together to form a stack, heating the stack and activating the ultraviolet cured coating layer with an ultraviolet radiation source, and removing the donor substrate from the stack, wherein the ultraviolet curable coating layer adheres to the recipient substrate first surface and the conductive layer.

The substrate (e.g., donor substrate, recipient substrate) can be formed by any polymer forming process. For example, a substrate can be formed by a co-extrusion process. The substrate can be co-extruded into a flat sheet. The substrate can be co-extruded into a flat sheet including a first surface comprising a first polymer and a second surface comprising a second polymer having a different chemical composition than the first polymer. The substrate can be co-extruded into a flat sheet including a first surface consisting of only a first polymer and a second surface consisting of only a second polymer having a different chemical composition than the first polymer. The substrate can be co-extruded into a flat sheet including a first surface consisting of polycarbonate and a second surface consisting of poly(methyl methacrylate) (PMMA).

An ultraviolet cured coating layer can be applied to a surface of the substrate first surface, wherein the ultraviolet cured coating layer comprises a multifunctional acrylate oligomer and an acrylate monomer, wherein the ultraviolet cured coating layer includes a total weight, wherein 30% to 80% of the total weight comprises the multifunctional acrylate oligomer, and wherein 15% to 65% of the total weight comprises the acrylate monomer. The UV curable coating layer can be applied to a substrate using any suitable wet coating process, such as spray coating, dip coating, roll coating, and the like.

A conductive layer and optional donor substrate can then be applied to the ultraviolet curable coating layer. The conductive layer can be applied to a substrate using any suitable wet coating process, such as spray coating, dip coating, roll coating, and the like. The ultraviolet cured coating layer can then be activated with an ultraviolet radiation source to adhere the conductive layer to the substrate. If a donor substrate is attached to the conductive layer second surface, the donor substrate can then be removed from the stack leaving the ultraviolet cured coating layer adhered to the conductive layer.

The conductive layer can be transferred from a donor substrate to a recipient substrate. The substrates can be heated. The substrates can be heated to a temperature of greater than or equal to 70° C. The substrates can be heated to a temperature of 70° C. to 95° C. The conductive layer can be applied to a donor substrate second surface. The conductive layer can be provided already adhered to the donor substrate. The ultraviolet curable coating layer can be applied to a surface of the conductive layer adjacent to the donor substrate. The ultraviolet curable coating layer can be applied to a surface of the recipient substrate. The ultraviolet curable coating layer can be applied to the substrate or conductive layer using any wet coating technique. The donor and recipient substrates can be pressed together to form a stack, where the ultraviolet curable coating layer and the conductive layer can be sandwiched between surfaces of the donor and recipient substrates to form a stack. Pressing can be performed by any suitable device, e.g., roller pressing, belt pressing, double belt pressing, stamping, die pressing, or a combination comprising at least one of the foregoing. The pressing device can be used to remove air bubbles trapped between the substrates. The pressing can include pressing the donor and recipient substrates together to a pressure of greater than 0.2 megaPascal (MPa), for example, 0.2 MPa to 1 MPa, or, 0.2 MPa to 0.5 MPa, or, 0.3 MPa, while the conductive layer and ultraviolet curable coating layer are sandwiched in between the donor and recipient substrates. The stack can be exposed to heat, ultraviolet (UV) light or some other cure initiator to cure the ultraviolet curable coating layer. The donor substrate can be removed, leaving behind the recipient substrate having a securely adhered conductive layer including the ultraviolet curable coating layer.

The conductive layer can be directly applied to a substrate (e.g., recipient substrate) via the UV curable coating layer. In other words, in such embodiment, the conductive layer is not formed on, applied to, or provided with a donor substrate. The ultraviolet curable coating layer can be applied to the conductive layer first surface or the substrate first surface. The conductive layer, ultraviolet curable coating layer, and substrate can be pressed together to form a stack, wherein the ultraviolet curable coating layer is sandwiched in between the conductive layer and the substrate. The pressing can include pressing the donor and recipient substrates together to a pressure of greater than 0.2 megaPascal (MPa), for example, 0.2 MPa to 1 MPa, or, 0.2 MPa to 0.5 MPa, or, 0.3 MPa. The stack can be exposed to heat, ultraviolet (UV) light or some other cure initiator to cure the ultraviolet curable coating layer, adhering the conductive layer to the substrate.

Curing the ultraviolet curable coating layer can include waiting, heating, drying, exposing to electromagnetic radiation (e.g., electromagnetic radiation (EMR) in the UV spectrum), or a combination of one of the foregoing. The adhesion between the ultraviolet curable coating layer and a donor or recipient substrate can be determined following ASTM D3359. The adhesion, per ASTM D3359, between the ultraviolet curable coating layer and the polymer of the donor substrate can be 0B. The adhesion, per ASTM D3359, between the conductive layer and the donor substrate can be 0B. The adhesion between the ultraviolet curable coating layer and the polymer of the recipient substrate can be 5B. The adhesion between the conductive layer and the polymer of the recipient substrate can be 5B. The ultraviolet curable coating layer can have a greater adhesion for the polymer of the recipient substrate than for the polymer of the donor substrate.

The mold insert can then be thermoformed to form a thermoformed article. Thermoforming the mold insert to form a thermoformed article can include placing the mold insert on a clamp of a mold, fixing the mold insert to the clamp, pushing the mold insert out of the clamp by raising the mold, lowering the mold, and heating the mold insert while simultaneously beginning the vacuum forming and raising the mold to form the thermoformed article.

A polymeric resin layer can be injection molded around a portion of the recipient substrate second surface. The injection molding can include placing the thermoformed mold insert into an injection mold, and injecting a polymeric resin material onto a portion of the recipient substrate second surface forming a polymeric resin layer on the recipient substrate second surface.

The mold insert (e.g., recipient substrate, donor substrate, ultraviolet curable coating layer, and conductive layer) can include a thermoplastic resin, a thermoset resin, or a combination comprising at least one of the foregoing. The polymeric resin layer can include a thermoplastic resin, a thermoset resin, or a combination comprising at least one of the foregoing.

Possible thermoplastic resins include, but are not limited to, oligomers, polymers, ionomers, dendrimers, copolymers such as graft copolymers, block copolymers (e.g., star block copolymers, random copolymers, and the like) or a combination comprising at least one of the foregoing. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (PI) (e.g., polyetherimides (PEI)), acrylonitrile-styrene-butadiene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyethylene terephthalate (PET), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluorides (PVF), polyvinylidene fluorides (PVDF), fluorinated ethylene-propylenes (FEP), polyethylene tetrafluoroethylenes (ETFE)), polyethylene naphthalates (PEN), cyclic olefin copolymers (COC), or a combination comprising at least one of the foregoing.

More particularly, a thermoplastic resin can include, but is not limited to, polycarbonate resins (e.g., LEXAN™ resins, including LEXAN™ CFR resins, commercially available from SABIC's Innovative Plastics business), polyphenylene ether-polystyrene resins (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate resins (e.g., XENOY™ resins, commercially available from SABIC's Innovative Plastics business), copolyestercarbonate resins (e.g., LEXAN™ SLX resins, commercially available from SABIC's Innovative Plastics business), or a combination comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer, polycarbonate-dimethyl bisphenol cyclohexane (DMBPC) polycarbonate copolymer (e.g., LEXAN™ DMX and LEXAN™ XHT resins commercially available from SABIC's Innovative Plastics business), polycarbonate-polyester copolymer (e.g., XYLEX™ resins, commercially available from SABIC's Innovative Plastics business),), linear polycarbonate, branched polycarbonate, end-capped polycarbonate (e.g., nitrile end-capped polycarbonate), or a combination comprising at least one of the foregoing, for example, a combination of branched and linear polycarbonate.

“Polycarbonates” as used herein further include homopolycarbonates, (wherein each R¹ in the polymer is the same), copolymers comprising different R¹ moieties in the carbonate (referred to herein as “copolycarbonates”), copolymers comprising carbonate units and other types of polymer units, such as ester units, and combinations comprising at least one of homopolycarbonates and/or copolycarbonates. As used herein, a “combination” is inclusive of blends, mixtures, alloys, reaction products, and the like.

The polycarbonate composition can further include impact modifier(s). Exemplary impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR) silicone elastomers, and elastomer-modified graft copolymers such as styrene-butadiene-styrene (SBS), styrene-butadiene rubber (SBR), styrene-ethylene-butadiene-styrene (SEBS), acrylonitrile-butadiene-styrene (ABS), acrylonitrile-ethylene-propylene-diene-styrene (AES), styrene-isoprene-styrene (SIS), methyl methacrylate-butadiene-styrene (MBS), high rubber graft (HRG), and the like. Impact modifiers are generally present in amounts of 1 to 30 wt. %, based on the total weight of the polymers in the composition.

The thermoplastic resins can include various additives ordinarily incorporated into polymer compositions of this type, with the proviso that the additive(s) are selected so as to not significantly adversely affect the desired properties of the polymeric composition, in particular hydrothermal resistance, water vapor transmission resistance, puncture resistance, and thermal shrinkage. Such additives can be mixed at a suitable time during the mixing of the components for forming the composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as titanium dioxide, carbon black, and organic dyes, surface effect additives, radiation stabilizers, flame retardants, and anti-drip agents. A combination of additives can be used, for example a combination of a heat stabilizer, mold release agent, and ultraviolet light stabilizer. The total amount of additives (other than any impact modifier, filler, or reinforcing agents) is generally 0.01 to 5 wt. %, based on the total weight of the composition.

Light stabilizers and/or ultraviolet light (UV) absorbing stabilizers can also be used. Exemplary light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or combinations comprising at least one of the foregoing light stabilizers. Light stabilizers are used in amounts of 0.01 to 5 parts by weight, based on 100 parts by weight of the total composition, excluding any filler.

UV light absorbing stabilizers include triazines, dibenzoylresorcinols (such as TINUVIN* 1577 commercially available from BASF and ADK STAB LA-46 commercially available from Asahi Denka), hydroxybenzophenones; hydroxybenzotriazoles; hydroxyphenyl triazines (e.g., 2-hydroxyphenyl triazine); hydroxybenzotriazines; cyanoacrylates; oxanilides; benzoxazinones; 2-(2H-benzotriazol-2-yl)-4-(1,1,3,3-tetramethylbutyl)-phenol (CYASORB* 5411); 2-hydroxy-4-n-octyloxybenzophenone (CYASORB* 531); 2-[4,6-bis(2,4-dimethylphenyl)-1,3,5-triazin-2-yl]-5-(octyloxy)-phenol (CYASORB* 1164); 2,2′-(1,4-phenylene)bis(4H-3,1-benzoxazin-4-one) (CYASORB* UV-3638); 1,3-bis[(2-cyano-3,3-diphenylacryloyl)oxy]-2,2-bis[[(2-cyano-3, 3-diphenylacryloyl)oxy]methyl]propane (UVINUL* 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with a particle size less than or equal to 100 nanometers, or combinations comprising at least one of the foregoing UV light absorbing stabilizers. UV light absorbing stabilizers are used in amounts of 0.01 to 5 parts by weight, based on 100 parts by weight of the total composition, excluding any filler.

The recipient substrate can include polycarbonate. The recipient substrate can include poly(methyl methacrylate) (PMMA). The recipient substrate can include polyethylene terephthalate (PET). The recipient substrate can include polyethylene naphthalate (PEN). The recipient substrate can include glass. The recipient substrate can include a combination comprising at least one of the foregoing. The donor substrate can include polyethylene terephthalate (PET). The ultraviolet curable coating layer can be applied to a surface of the substrate comprising polycarbonate. The ultraviolet curable coating layer can be applied to a surface of the substrate consisting of polycarbonate. The ultraviolet curable coating layer can be disposed between the conductive layer and a surface of the substrate comprising polycarbonate. The conductive layer can be disposed between the ultraviolet curable coating layer and a surface of the substrate consisting of polycarbonate.

### EXAMPLES

In the following examples, haze was tested according to ASTM D1003 procedure A using CIE standard illuminant C using a Haze-Gard test device, while adhesion between the ultraviolet curable coating layer and the substrate was measured according to ASTM D3359, where a value of 5B mean 100% adhesion on the substrate and 0B means 100 delamination between the ultraviolet curable coating layer and the substrate. The relationship between conductive film elongation percentage and surface resistivity was characterized by a Dynamic Mechanical Analysis (DMA) method.

The conductive film used is commercially available from CIMA (SANTE™) which uses self-aligning nano-technology to obtain a silver network on a substrate. There are two types of SANTE™ film, one is a SANTE™ film with a transfer resin, which is for easy transfer from a base, e.g., PET, to another substrate, while the other SANTE™ film is without a transfer resin. Properties for these two types of film are illustrated in Table 1.

TABLE 1
Performance Properties of SANTE ™ Film

| | Transmission | Haze | SR |
|---|---|---|---|
| | (%) | (%) | (Ω) |
| SANTE ™ with transfer resin | 80.8 | 6 | |
| SANTE ™ without transfer resin | 81.9 | 4.27 | 47.1 |

In the examples, a 0.178 mm transparent polycarbonate film was used as the substrate with a SANTE™ nano-silver network as the conductive layer.

To apply the ultraviolet curable coating layer and conductive layer to the substrate, the first surface of the recipient polycarbonate substrate was coupled to the conductive layer optionally attached to a donor substrate, where the ultraviolet curable transfer coating was disposed between the first surface of recipient substrate and the first surface of the conductive layer. The recipient substrate conductive layer were pressed together, then placed into an oven at 95° C. for 1 minute. If present, the donor substrate was removed from the conductive layer to form a conductive multilayer mold insert. UV curing was carried out using a Fusion UV machine, model F300S-6 processor using an H bulb at 300 Watts per inch, at 7 meters per minute under ambience. After UV curing, if present, the donor substrate PET film was released, while the ultraviolet curable coating layer remained adhered to the recipient substrate first surface and the conductive layer.

To thermoform the mold insert, the mold insert was placed and fixed on the clamp; the mold was raised to push the mold insert out of the clamp before the mold insert was heated, so that the tensile stress would be decreased in the forming process. The mold was released and began to push downward, the mold insert was heated and the temperature of the heater was set to 400° C., and after 12 seconds to 15 seconds, the mold insert surface temperature can reach 160° C. to 175° C. At the same time, the vacuum on the mold is started and the mold raised with the upper heater left on for a few seconds until the mold touches the mold insert.

The thermoformed molded insert was placed into an injection mold, and a polymeric resin material of SABIC LEXAN™ 1414T-NA was injected into the mold such that the polymeric resin material is deposited on the recipient substrate second surface. The injection molding conditions include an injection speed of 10/100/40 mm/s, an injection pressure of 2950 kgf/cm², a melt temperature of 310° C., a mold temperature of 70° C., and a pressure of 220 kgf/cm².

As seen in Tables 2 to 3, several kinds of UV coating formulations were tested. For example, several multifunctional acrylate oligomers were evaluated to offer related properties of the ultraviolet curable coating layer and adhesion between the conductive layer and the ultraviolet curable coating layer. It was found that HDDA offers adhesion between the ultraviolet curable coating layer and the substrate. For example, 30% HDDA content can provide sufficient adhesion between the ultraviolet curable coating layer and the substrate. Runtecure™ 1104 was used as a photoinitiator to facilitate curing of the ultraviolet curable coating layer under UV exposure. The ultraviolet coating liquids were blended with a different ratio that were heated at 30 minutes at 60° C. in an oven to achieve dispersion.

Formulations 1-7 were used to transfer the conductive layer from a donor substrate onto the recipient substrate by ultraviolet curing transfer technology, and Formulations 8-20 were used to laminate the conductive layer to the recipient substrate via the ultraviolet curable coating layer. The molded inserts were evaluated for formability by a vacuum thermoforming process with a tool. After thermoforming, the thermoformed molded inserts were injection molded with a polycarbonate resin forming the final article. The articles were evaluated for various performance properties including transmission, haze, SR, and compared with data for the molded insert before the thermoforming process. Each of Formulations 1 to 19 contained 5 wt. % photoinitiator. All amounts listed in Tables 2 to 3 are listed in weight percent. Formulation 7 includes 15 wt. % TPGDA and Formulation 8 includes 55 wt. % TPGDA.

TABLE 2
Ultraviolet Curable Coating Layer Formulations

| | | | | Allnex | | | | |
|---|---|---|---|---|---|---|---|---|
| | | | | EB8405 | | | | |
| | | Double Bond | | (20 wt. % | | | Cognis | Sartomer |
| # | HDDA | DM554 | DM583-1 | HDDA) | EB8402 | EB8807 | PM6892 | CN981 |
| 1 | 30 | | 65 | | | | | |
| 2 | 30 | | | 65 | | | | |
| 3 | 30 | | | | 65 | | | |
| 4 | 30 | | | | | 65 | | |
| 5 | 30 | | | | | | 65 | |
| 6 | 30 | | | | | | | 65 |
| 7 | 25 | 55 | | | | | | |

TABLE 3
Ultraviolet Curable Coating Layer Formulations

| | | | Cognis | Sartomer | | | Allnex | |
|---|---|---|---|---|---|---|---|---|
| # | HDDA | TPGDA | PN6892 | CN9001 | CN704 | CN991 | EB8402 | EB303 |
| 8 | 45 | 55 | | | | | | |
| 9 | 30 | | | | | 35 | | 30 |
| 10 | 30 | | | | | | 35 | 30 |
| 11 | 30 | | | | 30 | | 35 | |
| 12 | 30 | | 35 | | 30 | | | |
| 13 | 30 | | 35 | | | | | 30 |
| 14 | 30 | | | 35 | 30 | | | |
| 15 | 30 | | | 35 | | | | 30 |
| 16 | 95 | | | | | | | |
| 17 | 40 | | | | | 55 | | |
| 18 | | | | | | | 55 | |
| 19 | | | 55 | | | | | |
| 20 | | | | 55 | | | | |

Tables 4 to 9 illustrate various properties of the multilayer sheet before and after thermoforming, and before and after injection molding. Tables 5, 6, 8 and 9 illustrate various properties measured at various points on the thermoformed part and injection molded article at various locations illustrated in FIG. 3.

TABLE 4
Surface Resistivity (SR) and Color Comparison Before and After Thermoforming

| | | | | | After Thermoforming | | |
|---|---|---|---|---|---|---|---|
| | | Before Thermoforming | | | SR (Ω) | | |
| Formulation # | Sample | SR (Ω) | Transmission | Haze | (Min.-Max) | Transmission | Haze |
| 1 | 1 | 6.2 | 81.9 | 3.3 | 6.6-∞ | 81.4 | 3.81 |
| 1 | 2 | 6.6 | 80.5 | 4.39 | 7.1-140.7 | 80.3 | 4.97 |
| 1 | 3 | 4.6 | 82.2 | 3.2 | 6.0-50 | 81.7 | 3.26 |
| 2 | 1 | 6.0 | 81.7 | 3.44 | 6.7-∞ | 81.7 | 3.4 |
| 2 | 2 | 5.7 | 81.7 | 3.37 | 3.7-∞ | 81.5 | 3.46 |
| 2 | 3 | 6.7 | 80.6 | 4.37 | 4.9-∞ | 80.2 | 4.27 |
| 3 | 1 | 5.3 | 80.6 | 4.8 | 6.6-∞ | 80.3 | 4.43 |
| 3 | 2 | 6.7 | 81.4 | 3.51 | 6.0-∞ | 81.2 | 3.7 |
| 3 | 3 | 7.0 | 81.6 | 3.37 | 6.5-∞ | 81.5 | 3.63 |
| 4 | 1 | 4.7 | 82.1 | 3.29 | 6.3-∞ | 81.4 | 3.74 |
| 4 | 2 | 6.7 | 81.6 | 3.42 | 5.7-91.5 | 81.6 | 3.59 |
| 4 | 3 | 7.0 | 80.4 | 4.19 | 5.0-∞ | 80.2 | 4.52 |
| 5 | 1 | 7.1 | 80.5 | 4.21 | 6.6-∞ | 80.5 | 4.42 |
| 5 | 2 | 6.3 | 81.9 | 3.32 | 4.0-∞ | 81.7 | 3.68 |
| 5 | 3 | 7.9 | 81.6 | 3.37 | 6.7-∞ | 82.1 | 3.35 |
| 6 | 1 | 5.4 | 81.5 | 3.33 | 7.7-∞ | 81.5 | 3.51 |
| 6 | 2 | 6.7 | 80.6 | 4.14 | 6.2-∞ | 80.4 | 4.37 |
| 6 | 3 | 7.9 | 81.8 | 3.39 | 6.6-∞ | 81.5 | 3.66 |
| 7 | 1 | 5.2 | 81.7 | 3.43 | 0-∞ | 81.5 | 3.83 |
| 7 | 2 | 5.8 | 80.3 | 4.48 | 6.5-∞ | 80.2 | 4.6 |
| 7 | 3 | 7.6 | 81.7 | 3.37 | 0-∞ | 81.5 | 3.68 |

TABLE 5
Surface Resistivity (SR) at Different Positions on Thermoformed Part

| Formulation | | SR at Different Positions on Thermoforming Part | | | | | | | | |
|---|---|---|---|---|---|---|---|---|---|---|
| # | Sample | 1 | 3 | 5 | 8 | 10 | 15 | 4 | 9 | 14 |
| 1 | 1 | ∞ | 6.6 | 8.1 | 7.3 | 6.9 | ∞ | ∞ | ∞ | ∞ |
| 1 | 2 | 41.9 | 7.1 | 20.0 | 9.9 | 6.7 | 39.7 | 55.3 | 21.6 | 140.7 |
| 1 | 3 | 30.2 | 12.0 | 6.2 | 8.8 | 6.0 | 48.3 | 36.3 | 25.0 | 50.0 |
| 2 | 1 | 56.3 | 8.0 | 16.3 | 13.4 | 6.7 | 150.0 | 145.8 | 41.8 | ∞ |
| 2 | 2 | 75.0 | 7.8 | 16.0 | 9.9 | 3.7 | 88.7 | 92.3 | 68.5 | ∞ |
| 2 | 3 | 53.3 | 7.0 | 11.2 | 7.9 | 4.9 | ∞ | 29.7 | 16.0 | ∞ |
| 3 | 1 | 101.5 | 8.7 | 78.5 | 53.1 | 6.6 | ∞ | 87.4 | 40.5 | ∞ |
| 3 | 2 | 71.2 | 11.9 | 32.0 | 21.5 | 6.0 | 82.1 | 78.7 | 51.2 | ∞ |
| 3 | 3 | 139.5 | 9.2 | 31.4 | 28.7 | 6.5 | 177.6 | 143.6 | 154.1 | ∞ |
| 4 | 1 | 23.5 | 6.3 | 8.3 | 7.0 | 14.6 | 53.0 | 26.6 | 16.8 | ∞ |
| 4 | 2 | 39.2 | 8.9 | 7.3 | 5.7 | 5.0 | 39.6 | 58.0 | 38.1 | 91.5 |
| 4 | 3 | 17.2 | 6.7 | 6.9 | 5.0 | 6.4 | 26.2 | 26.2 | 10.4 | ∞ |
| 5 | 1 | 38.4 | 7.7 | 8.0 | 8.7 | 6.6 | 95.5 | 45.0 | 29.7 | ∞ |
| 5 | 2 | 46.9 | 4.5 | 10.5 | 6.3 | 4.0 | 28.5 | 76.8 | 24.2 | ∞ |
| 5 | 3 | 44.4 | 8.4 | 10.7 | 17.7 | 6.7 | 59.4 | 52.0 | 19.9 | ∞ |
| 6 | 1 | 50.3 | 7.7 | 9.7 | 8.6 | 9.2 | 38.8 | 31.1 | 21.8 | ∞ |
| 6 | 2 | 31.6 | 8.1 | 9.9 | 8.5 | 6.2 | ∞ | ∞ | 22.4 | ∞ |
| 6 | 3 | 31.8 | 7.4 | 8.0 | 8.7 | 6.6 | 95.5 | 45.0 | 29.7 | ∞ |
| 7 | 1 | ∞ | 11.3 | 47.7 | 57.4 | 7.6 | ∞ | ∞ | 0.0 | ∞ |
| 7 | 2 | ∞ | 11.1 | 54.9 | 29.7 | 6.5 | ∞ | 175.7 | 122.4 | ∞ |
| 7 | 3 | ∞ | 62.3 | 28.1 | 16.3 | 5.1 | ∞ | ∞ | 0.0 | ∞ |

TABLE 6
Surface Resistivity (SR) After Injection Molding

| Formulation | | SR (Ω) | SR at Different Positions After Injection Molding | | | | | | |
|---|---|---|---|---|---|---|---|---|---|
| # | Sample | (Min.-Max) | 3 | 8 | 10 | 13 | 4 | 9 | 14 |
| 1 | 1 | 7-30.6 | 9.7 | 7 | 11.8 | 9.6 | 20.6 | 18.5 | 30.6 |
| 1 | 2 | 7.3-24.1 | 16.4 | 7.3 | 12.6 | 9.6 | 24.1 | 23.5 | 12.1 |
| 1 | 3 | 8.1-25.3 | 17.5 | 8.1 | 12.3 | 11.3 | 14.1 | 10.5 | 25.3 |
| 2 | 1 | 7.4-22.8 | 9.8 | 6.9 | 14 | 7.4 | 22.7 | 22.5 | 22.8 |
| 2 | 2 | 7.6-53.4 | 19.3 | 7.6 | 17.1 | 9.3 | 53.4 | 12.8 | 15.4 |
| 2 | 3 | 9.8-35.4 | 12.9 | 10.9 | 24.2 | 9.8 | 35.4 | 10.4 | 9.8 |
| 3 | 1 | 2.1-40.1 | 11.6 | 3.1 | 12.5 | 9.8 | 2.1 | 10.2 | 40.1 |
| 3 | 2 | 8-41 | 16.3 | 8 | 11.7 | 8.9 | 41 | 10.8 | 35.1 |
| 3 | 3 | 4.4-73.4 | 18.9 | 4.4 | 12 | 9.1 | 34.5 | 17.3 | 73.4 |
| 4 | 1 | 7.4-33.1 | 20.9 | 7.4 | 8.1 | 16.3 | 9.9 | 18.4 | 33.1 |
| 4 | 2 | 3.9-14.9 | 3.9 | 7.4 | 14.1 | 9.3 | 14.9 | 12.6 | 13.8 |
| 4 | 3 | 3.9-14.5 | 8.9 | 4.1 | 12.2 | 4.2 | 3.9 | 5 | 14.5 |
| 5 | 1 | 8.5-17 | 10.8 | 8.5 | 13.3 | 9.3 | 9.2 | 11.5 | 17 |
| 5 | 2 | 6.9-19.1 | 6.9 | 8 | 11.8 | 9.1 | 19.1 | 9.3 | 14.5 |
| 5 | 3 | 7-19.7 | 16.7 | 8.3 | 13.6 | 7 | 18.5 | 16.2 | 19.7 |
| 6 | 1 | 7.7-19.1 | 17 | 7.7 | 12.8 | 11.1 | 13.7 | 17.4 | 19.1 |
| 6 | 2 | 7.6-17 | 17 | 8 | 12.5 | 7.6 | 10.8 | 16.8 | 13.8 |
| 6 | 3 | 8.6-28 | 14.3 | 10.7 | 12.6 | 8.6 | 28 | 11.7 | 12.3 |
| 7 | 1 | 3.9-34.7 | 11.6 | 9.9 | 15.6 | 9.9 | 17.3 | 34.7 | 3.9 |
| 7 | 2 | 10.1-26.9 | 26.9 | 11.8 | 15.1 | 10.1 | 12.1 | 26 | 15.6 |
| 7 | 3 | 10.8-29.6 | 25.1 | 11.2 | 15.2 | 10.8 | 29.6 | 14.1 | 25.9 |

TABLE 7
Surface Resistivity (SR) and Color Comparison Before and After Thermoforming

| | | | | After Thermoforming | | |
|---|---|---|---|---|---|---|
| | Before Thermoforming | | | SR (Ω) | | |
| Formulation # | SR (Ω) | Transmission | Haze | (Min.-Max) | Transmission | Haze |
| 8 | 52.8 | 80.5 | 5.23 | 28.2-106.5 | 81.2 | 4.52 |
| 9 | 56.2 | 82.5 | 4.11 | 35.6-85.6 | 81.6 | 4.16 |
| 10 | 63.3 | 82.4 | 4.18 | 32.4-105.5 | 83.2 | 3.54 |
| 11 | 52.6 | 81.1 | 4.44 | 29.9-73.7 | 81.1 | 4.25 |
| 12 | 58.4 | 81.3 | 4.63 | 32.1-66 | 81.3 | 4.33 |
| 13 | 49.5 | 81.9 | 5.38 | 30.8-67.7 | 81.3 | 5.85 |
| 14 | 53.3 | 81 | 4.81 | 26-52 | 80.5 | 4.71 |
| 15 | 54.0 | 81.9 | 4.42 | 19.3-75.1 | 81.5 | 4.12 |
| 16 | 51.3 | 81.4 | 4.49 | 29.7-116 | 81.1 | 4.19 |
| 17 | 46.9 | 82.6 | 4.13 | 34.1-105.2 | 82.8 | 3.71 |
| 18 | 54.2 | 82 | 4.3 | 31.9-88 | 81.6 | 4.09 |
| 19 | 49.2 | 80.9 | 6.14 | 29.3-69 | 80.1 | 5.11 |
| 20 | 50.4 | 81.2 | 4.55 | 28.8-50.5 | 80.3 | 4.03 |

TABLE 8
Surface Resistivity (SR) at Different Positions on Thermoformed Part

| | SR at Different Positions After Thermoforming Part | | | | | | | | |
|---|---|---|---|---|---|---|---|---|---|
| Formulation # | 1 | 3 | 5 | 8 | 10 | 15 | 4 | 9 | 14 |
| 8 | 37.8 | 28.2 | 29.3 | 33.0 | 28.2 | 33.7 | 35.4 | 39.9 | 106.5 |
| 9 | 41.9 | 36.8 | 43.7 | 47.7 | 35.6 | 42.0 | 60.3 | 39.5 | 85.6 |
| 10 | 43.7 | 32.4 | 34.9 | 37.4 | 40.1 | 41.1 | 66.0 | 42.6 | 105.5 |
| 11 | 41.2 | 32.2 | 42.1 | 29.9 | 36.5 | 40.4 | 51.0 | 41.6 | 73.7 |
| 12 | 40.7 | 32.1 | 34.0 | 33.8 | 33.3 | 44.4 | 36.4 | 61.9 | 66.0 |
| 13 | 33.5 | 39.9 | 35.5 | 32.6 | 30.8 | 40.2 | 35.9 | 39.9 | 67.7 |
| 14 | 42.2 | 31.8 | 29.0 | 37.0 | 31.0 | 31.8 | 40.7 | 36.9 | 52.0 |
| 15 | 40.0 | 28.7 | 31.2 | 34.0 | 31.8 | 19.3 | 42.8 | 43.3 | 75.1 |
| 16 | 33.7 | 34.6 | 29.7 | 36.6 | 29.8 | 37.7 | 53.3 | 34.5 | 116.0 |
| 17 | 40.9 | 34.1 | 38.0 | 36.2 | 31.3 | 41.2 | 42.2 | 27.4 | 105.2 |
| 18 | 40.7 | 33.4 | 38.7 | 32.4 | 31.9 | 44.3 | 50.5 | 36.0 | 88.0 |
| 19 | 38.6 | 33.6 | 36.5 | 29.3 | 30.5 | 46.6 | 39.2 | 32.9 | 69.0 |
| 20 | 31.1 | 33.4 | 39.0 | 34.9 | 28.8 | 40.3 | 32.5 | 32.5 | 50.5 |

TABLE 9
Surface Resistivity (SR) After Injection Molding

| | SR (Ω) | SR at Different Positions After Injection Molding | | | | | | |
|---|---|---|---|---|---|---|---|---|
| Formulation # | (Min.-Max) | 3 | 8 | 10 | 13 | 4 | 9 | 14 |
| 8 | 13-46.2 | 13 | 25.8 | 46.2 | 29.6 | 33.2 | 34.4 | 42.3 |
| 9 | 14.4-46.6 | 40 | 14.7 | 15.9 | 34.2 | 14.4 | 46.6 | 14.7 |
| 10 | 16.5-48 | 16.8 | 23.4 | 51.3 | 16.5 | 47 | 30.1 | 48 |
| 11 | 23.5-92.1 | 33.8 | 32 | 33.2 | 33.8 | 92.1 | 23.5 | 46.1 |
| 12 | 31.6-112.1 | 31.8 | 31.6 | 45.1 | 33.4 | 42.9 | 38.4 | 112.1 |
| 13 | 25.9-90.2 | 39.3 | 33.2 | 90.2 | 39 | 38.9 | 25.9 | 51.6 |
| 14 | 22.7-57.4 | 33.3 | 22.7 | 48.8 | 36 | 42.3 | 57.4 | 50 |
| 15 | 14.6-49.5 | 11.8 | 34.3 | 14.6 | 36.5 | 25.5 | 33.3 | 49.5 |
| 16 | 11-45.5 | 11 | 16.6 | 42.9 | 33.2 | 40.8 | 25.1 | 45.5 |
| 17 | 22.1-39.8 | 37.2 | 22.1 | 39.2 | 37.4 | 43.4 | 39.8 | 31.7 |
| 18 | 20.7-38.2 | 32.9 | 32.1 | 20.7 | 36.8 | 36 | 38.2 | 33 |
| 19 | 19.1-40.6 | 35.5 | 35.9 | 40.6 | 34.4 | 39.2 | 19.1 | 36 |
| 20 | 35.2-49.1 | 38.8 | 49.3 | 45.9 | 35.2 | 38.8 | 49.1 | 45.2 |

Each of the UV coating formulations 1 to 7 can transfer the conductive layer to the polycarbonate substrate with good adhesion successfully. As can be seen in Table 4, transmission was maintained greater than or equal to 70%, for example, greater than or equal to 75%, for example, greater than or equal to 80%, while haze was measured at less than or equal to 9, for example, less than or equal to 7, for example, less than or equal to 6, for example, less than or equal to 5, for example, less than or equal to 3.

After thermoforming, transmission and haze of the majority of the mold inserts did not change drastically and most parts have the same color performance. Formability was checked by visual inspection first and the results demonstrated that the mold insert made with ultraviolet curable coating layer formulations 1 and 4, which demonstrated only slight cracking issues at point 14 in FIG. 3 of the thermoformed part. The thermoformed mold inserts can be trimmed before the IMD process to remove any cracking at the edges.

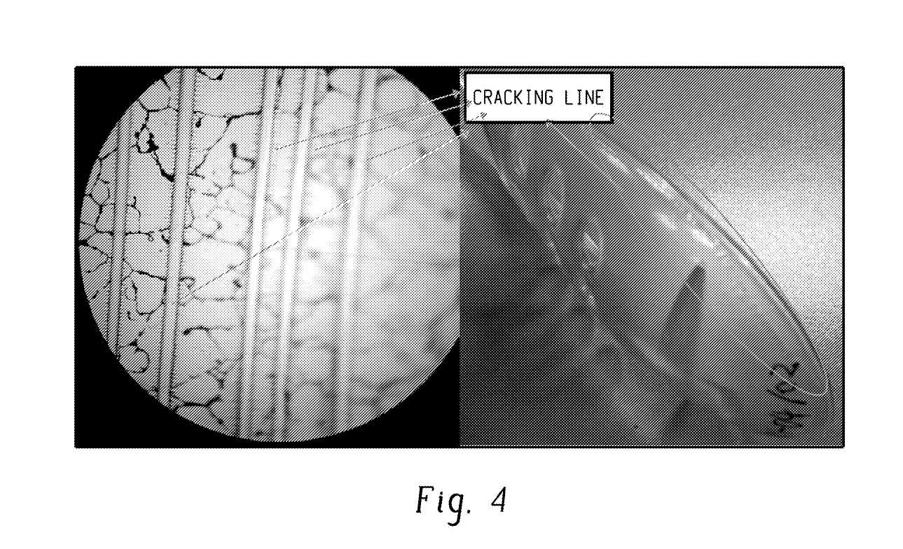

Various points on the peanut part 3D structure illustrated in FIG. 3 were chosen to measure SR based on different stretch level after thermoforming and injection molded. The original SR of the transferred conductive polycarbonate film with the transfer resin is about 6Ω. An SR of “∞” indicates no conductivity because the silver network breaks under deep stretch. FIG. 4 is a microscopic picture of conductive layer nano-silver network, where cracking lines may be found on the surface. The SR could be maintained very well, particularly for formulations 1, 4, 5, and 6, which demonstrate stable and robust SR due to excellent elongation performance.

Formulations 8-20 successfully laminated the conductive layer without a transfer resin to a polycarbonate substrate with good adhesion. The transmission can be maintained greater than or equal to 70%, for example, greater than or equal to 75%, for example, greater than or equal to 80%, while haze was measured at less than or equal to 9, for example, less than or equal to 7, for example, less than or equal to 6, for example, less than or equal to 5, for example, less than or equal to 4%. After thermoforming, the transmission and haze essentially does not change and the films essentially kept the same color and performance. Similarly, good conductivity of the thermoformed mold inserts was found, especially for Formulations 9, 11, 15, 19, and 20 because of good elongation performance.

Various points on the peanut part 3D structure illustrated in FIG. 3 were chosen to measure SR values. The original SR of the polycarbonate conductive film without the transfer resin was about 50Ω. The SR was maintained after thermoforming, for example, less than 70Ω, and for example less than 65Ω. Particular successful formulations include Formulations 12-14 which demonstrate stable and robust SR values due to excellent elongation performance. All of the formulations demonstrate stable and robust SR after injection molding, except Formulations 11-13.

It can be concluded that the formability of the transferred polycarbonate conductive multilayer sheet relies mainly on the flexibility of the UV formulation. Mold inserts made with the described coating formulations illustrate good thermoforming performance due to good flexibility and formability. Further, conductivity will be changed under a different stretch level, basically a higher stretch level will lose some conductivity.

The article of manufacture and methods of making disclosed herein include at least the following embodiments:

### Embodiment 1

An article of manufacture, comprising: a mold insert comprising a substrate including a substrate first surface and a substrate second surface; an ultraviolet curable coating layer including a coating first surface and a coating second surface, wherein the ultraviolet curable coating layer comprises a multifunctional acrylate oligomer; and an acrylate monomer; wherein the ultraviolet curable coating layer includes a total weight, wherein 30% to 80% of the total weight comprises the multifunctional acrylate oligomer, and wherein 15% to 65% of the total weight comprises the acrylate monomer, wherein the coating first surface of the ultraviolet curable coating layer is adjacent to the substrate first surface; and a conductive layer adjacent to the coating second surface, wherein the conductive layer includes nanometer sized metal particles arranged in a network; and a polymeric resin layer coupled to a portion of the substrate second surface.

### Embodiment 2

The article of manufacture of Embodiment 1, wherein the acrylate monomer comprises 1,6-hexanediol diacrylate, tripropylene glycol diacrylate (TPGDA), or a combination comprising at least one of the foregoing.

### Embodiment 3

The article of manufacture of Embodiment 1 or Embodiment 2, wherein the multifunctional acrylate oligomer comprises an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing.

### Embodiment 4

The article of manufacture of any of Embodiments 1-3, wherein the ultraviolet curable coating layer further comprises a photoinitiator, wherein 3% to 7% of the total weight comprises the photoinitiator.

### Embodiment 5

The article of manufacture of Embodiment 4, wherein the photoinitiator comprises an α-hydroxyketone photoinitiator.

### Embodiment 6

The article of manufacture of Embodiment 5, wherein the α-hydroxyketone photoinitiator is 1-hydroxy-cyclohexylphenylketone.

### Embodiment 7

The article of manufacture of any of Embodiments 1-6, wherein the substrate comprises polycarbonate, poly(methyl methacrylate) (PMMA), polyethylene terephthalate (PET), polyethylene naphthalate (PEN), a cyclic olefin copolymer (COC), polyetherimide (PEI), polystyrene, polyimide, polypropylene (PP), polyethylene (PE), polyvinyl fluoride (PVF), polyvinylidene fluoride (PVDF), glass, or a combination comprising at least one of the foregoing.

### Embodiment 8

The article of manufacture of any of Embodiments 1-7, wherein the article of manufacture has a transmittance of greater than or equal to 80% as measured according to ASTM D1003 Procedure A using CIE standard illuminant C.

### Embodiment 9

The article of manufacture of any of Embodiments 1-8, wherein the article of manufacture has a haze value of 3% to 7% according to ASTM D1003.

### Embodiment 10

The article of manufacture of any of Embodiments 1-9, wherein the article of manufacture has a surface resistance of less than or equal to 75 Ohms.

### Embodiment 11

The article of manufacture of any of Embodiments 1-10, wherein the article is a touch screen display, a wireless electronic board, a photovoltaic device, a conductive textile, a conductive fiber, an organic light emitting diode, an electroluminescent device, an electrophoretic display, or a combination comprising at least one of the foregoing.

### Embodiment 12

A method of forming an article of manufacture, comprising: forming a mold insert, comprising applying a conductive layer on a donor substrate second surface, wherein the conductive layer includes nanometer sized metal particles arranged in a network; applying an ultraviolet curable coating layer to a recipient substrate first surface; pressing the recipient substrate, the ultraviolet curable coating layer, and the donor substrate together to form a stack; heating the stack and activating the ultraviolet cured coating layer with an ultraviolet radiation source; removing the donor substrate from the stack, wherein the ultraviolet curable coating layer adheres to the recipient substrate first surface and the conductive layer; thermoforming the mold insert; and injection molding a polymeric resin layer around a portion of the recipient substrate second surface.

### Embodiment 13

The method of Embodiment 12, wherein the recipient substrate and the donor substrate are independently selected from polycarbonate, poly(methyl methacrylate) (PMMA), polyethylene terephthalate (PET), polyethylene naphthalate (PEN), cyclic olefin copolymers (COC), polyetherimides (PEI), polystyrenes, polyimides, polypropylenes (PP), polyethylenes (PE), polyvinyl fluorides (PVF), polyvinylidene fluorides (PVDF), glass, or a combination comprising at least one of the foregoing.

### Embodiment 14

The method of Embodiment 12 or Embodiment 13, wherein the ultraviolet curable coating layer comprises a multifunctional acrylate oligomer and an acrylate monomer, wherein the ultraviolet cured coating layer includes a total weight, wherein 30% to 80% of the total weight comprises the multifunctional acrylate oligomer, and wherein 15% to 65% of the total weight comprises the acrylate monomer.

### Embodiment 15

The method of any of Embodiments 12-14, wherein the acrylate monomer comprises 1,6-hexanediol diacrylate, tripropylene glycol diacrylate (TPGDA), or a combination comprising at least one of the foregoing.

### Embodiment 16

The method of any of Embodiments 12-15, wherein thermoforming the mold insert comprises: placing the mold insert on a clamp of a mold; fixing the mold insert to the clamp; pushing the mold insert out of the clamp by raising the mold; lowering the mold; and heating the mold insert while simultaneously beginning the vacuum and raising the mold to form the thermoformed mold insert.

### Embodiment 17

The method of Embodiment 16 further comprising trimming the mold insert before injection molding the mold insert.

### Embodiment 18

The method of any of Embodiments 12-17, wherein the injection molding comprises: placing the thermoformed mold insert into an injection mold; and injecting a polymeric resin material onto a portion of the recipient substrate second surface forming a polymeric resin layer on the recipient substrate second surface.

### Embodiment 19

The method of any of Embodiments 12-18, wherein the polymeric material comprises polycarbonate, poly(methyl methacrylate) (PMMA), polyethylene terephthalate (PET), polyethylene naphthalate (PEN), cyclic olefin copolymers (COC), polyetherimides (PEI), polystyrenes, polyimides, polypropylenes (PP), polyethylenes (PE), poly(p-phenylene oxide) (PPO), polyether ether ketone (PEEK), polyvinyl fluorides (PVF), polyvinylidene fluorides (PVDF), glass, or a combination comprising at least one of the foregoing.

### Embodiment 20

The method of any of Embodiments 12-19, further comprising printing an image onto a surface of the recipient substrate.

Unless otherwise specified herein, any reference to standards, testing methods and the like, such as ASTM D1003, ASTM D3359, ASTM D3363, refer to the standard, or method that is in force at the time of filing of the present application.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. An article of manufacture, comprising:
a mold insert comprising
a substrate including a substrate first surface and a substrate second surface;
an ultraviolet curable coating layer including a coating first surface and a coating second surface, wherein the ultraviolet curable coating layer comprises
a multifunctional acrylate oligomer; and
an acrylate monomer;
wherein the ultraviolet curable coating layer includes a total weight, wherein 30% to 80% of the total weight comprises the multifunctional acrylate oligomer, and wherein 15% to 65% of the total weight comprises the acrylate monomer, wherein the coating first surface of the ultraviolet curable coating layer is adjacent to the substrate first surface; and
a conductive layer adjacent to the coating second surface, wherein the conductive layer includes nanometer sized metal particles arranged in a network; and
a polymeric resin layer coupled to a portion of the substrate second surface.

2. The article of manufacture of claim 1, wherein the acrylate monomer comprises 1,6-hexanediol diacrylate, tripropylene glycol diacrylate (TPGDA), or a combination comprising at least one of the foregoing.

3. The article of manufacture of claim 1, wherein the multifunctional acrylate oligomer comprises an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing.

4. The article of manufacture of claim 1, wherein the ultraviolet curable coating layer further comprises a photoinitiator, wherein 3% to 7% of the total weight comprises the photoinitiator.

5. The article of manufacture of claim 4, wherein the photoinitiator comprises an α-hydroxyketone photoinitiator.

6. The article of manufacture of claim 5, wherein the α-hydroxyketone photoinitiator is 1-hydroxy-cyclohexylphenylketone.

7. The article of manufacture of claim 1, wherein the substrate comprises polycarbonate, poly(methyl methacrylate) (PMMA), polyethylene terephthalate (PET), polyethylene naphthalate (PEN), a cyclic olefin copolymer (COC), polyetherimide (PEI), polystyrene, polyimide, polypropylene (PP), polyethylene (PE), polyvinyl fluoride (PVF), polyvinylidene fluoride (PVDF), glass, or a combination comprising at least one of the foregoing.

8. The article of manufacture of claim 1, wherein the article of manufacture has a transmittance of greater than or equal to 80% as measured according to ASTM D1003 Procedure A using CIE standard illuminant C.

9. The article of manufacture of claim 1, wherein the article of manufacture has a haze value of 3% to 7% according to ASTM D1003.

10. The article of manufacture of claim 1, wherein the article of manufacture has a surface resistance of less than or equal to 75 Ohms.

11. The article of manufacture of claim 1, wherein the article is a touch screen display, a wireless electronic board, a photovoltaic device, a conductive textile, a conductive fiber, an organic light emitting diode, an electroluminescent device, an electrophoretic display, or a combination comprising at least one of the foregoing.

12. A method of forming an article of manufacture, comprising:
forming a mold insert, comprising
applying a conductive layer on a donor substrate second surface, wherein the conductive layer includes nanometer sized metal particles arranged in a network;
applying an ultraviolet curable coating layer to a recipient substrate first surface;
pressing the recipient substrate, the ultraviolet curable coating layer, and the donor substrate together to form a stack;
heating the stack and activating the ultraviolet cured coating layer with an ultraviolet radiation source;
removing the donor substrate from the stack, wherein the ultraviolet curable coating layer adheres to the recipient substrate first surface and the conductive layer;
thermoforming the mold insert; and
injection molding a polymeric resin layer around a portion of the recipient substrate second surface.

13. The method of claim 12, wherein the recipient substrate and the donor substrate are independently selected from polycarbonate, poly(methyl methacrylate) (PMMA), polyethylene terephthalate (PET), polyethylene naphthalate (PEN), cyclic olefin copolymers (COC), polyetherimides (PEI), polystyrenes, polyimides, polypropylenes (PP), polyethylenes (PE), polyvinyl fluorides (PVF), polyvinylidene fluorides (PVDF), glass, or a combination comprising at least one of the foregoing.

14. The method of claim 12, wherein the ultraviolet curable coating layer comprises a multifunctional acrylate oligomer and an acrylate monomer, wherein the ultraviolet cured coating layer includes a total weight, wherein 30% to 80% of the total weight comprises the multifunctional acrylate oligomer, and wherein 15% to 65% of the total weight comprises the acrylate monomer.

15. The method of claim 12, wherein the acrylate monomer comprises 1,6-hexanediol diacrylate, tripropylene glycol diacrylate (TPGDA), or a combination comprising at least one of the foregoing.

16. The method of claim 12, wherein thermoforming the mold insert comprises:
placing the mold insert on a clamp of a mold;
fixing the mold insert to the clamp;
pushing the mold insert out of the clamp by raising the mold;
lowering the mold; and
heating the mold insert while simultaneously beginning the vacuum and raising the mold to form the thermoformed mold insert.

17. The method of claim 16, further comprising trimming the mold insert before injection molding the mold insert.

18. The method of claim 12, wherein the injection molding comprises:
placing the thermoformed mold insert into an injection mold; and
injecting a polymeric resin material onto a portion of the recipient substrate second surface forming a polymeric resin layer on the recipient substrate second surface.

19. The method of claim 12, wherein the polymeric material comprises polycarbonate, poly(methyl methacrylate) (PMMA), polyethylene terephthalate (PET), polyethylene naphthalate (PEN), cyclic olefin copolymers (COC), polyetherimides (PEI), polystyrenes, polyimides, polypropylenes (PP), polyethylenes (PE), poly(p-phenylene oxide) (PPO), polyether ether ketone (PEEK), polyvinyl fluorides (PVF), polyvinylidene fluorides (PVDF), glass, or a combination comprising at least one of the foregoing.

20. The method of claim 12, further comprising printing an image onto a surface of the recipient substrate.
